(19) United States
(12) Patent Application Publication
(10) Pub. No.: US 2009/0013284 A1
(43) Pub. Date: Jan. 8, 2009

(54) Systems and Methods for Communicating Information

(75) Inventor: Lei Chen, Austin, TX (US)

Correspondence Address: Giorgos A. Georgakis;Chowdhury & Georgakis, PC, PO BOX 90277, AUSTIN, TX, 78709-0277, US

(73) Assignee: VirSyCom, Inc., Lakeway, TX (US)

(21) Appl. No.: 12/105,148

(22) Filed: Apr. 17, 2008

Related U.S. Application Data
(60) Provisional application No. 60/958,027, filed on Jul. 2, 2007.

(51) Int. Cl. G06F 3/048

(52) U.S. Cl. 715/810

(57) ABSTRACT

Methods and systems for communicating information are disclosed, including creating sequence instructions configured to define a set of permitted sequences for a plurality of documents. The sequence instructions may be sent to a user and interpreted using an active user interface for the user to select one or more sequences from the set of permitted sequences. The plurality of documents may then be executed in response to the selecting one or more of the sequences.

### I. PRIORITY CLAIM

This application claims priority to U.S. provisional application Ser. No. 60/958,027, filed on Jul. 2, 2007, the entire contents of which are hereby incorporated by reference herein for all purposes.

### II. BACKGROUND

The invention relates generally to the field of communicating information.

### III. SUMMARY

In one respect, disclosed is a method for communicating information, the method comprising creating sequence instructions, where the sequence instructions are configured to define a set of permitted sequences for controlling an execution of a plurality of documents, and where the sequence instructions are configured to be interpreted by an active user interface through which a user selects one or more sequences from the set of permitted sequences.

In another respect, disclosed is a system for communicating information, the system comprising: one or more processors; one or more memory units; the system being configured to create sequence instructions, where the sequence instructions are configured to define a set of permitted sequences for controlling an execution of a plurality of documents, and where the sequence instructions are configured to be interpreted by an active user interface through which a user selects one or more sequences from the set of permitted sequences.

In yet another respect, disclosed is a computer program product stored on a computer operable medium, the computer program product comprising software code being effective to create sequence instructions, where the sequence instructions are configured to define a set of permitted sequences for controlling an execution of a plurality of documents, and where the sequence instructions are configured to be interpreted by an active user interface through which a user selects one or more sequences from the set of permitted sequences.

In yet another respect, disclosed is a method for communicating information, the method comprising: receiving sequence instructions, where the sequence instructions are configured to define a set of permitted sequences for a plurality of documents; selecting one or more sequences from the set of permitted sequences in response to interpreting the sequence instructions using an active user interface; and executing one or more of the plurality of documents in response to selecting one or more of the sequences.

In yet another respect, disclosed is a system for communicating information, the system comprising: one or more processors; one or more memory units; the system being configured to: receive sequence instructions, where the sequence instructions are configured to define a set of permitted sequences for a plurality of documents; select one or more sequences from the set of permitted sequences in response to interpreting the sequence instructions using an active user interface; and execute one or more of the plurality of documents in response to selecting one or more of the sequences.

In yet another respect, disclosed is a computer program product stored on a computer operable medium, the computer program product comprising software code being effective to: receive sequence instructions, where the sequence instructions are configured to define a set of permitted sequences for a plurality of documents; select one or more sequences from the set of permitted sequences in response to interpreting the sequence instructions using an active user interface; and execute one or more of the plurality of documents in response to selecting one or more of the sequences.

Numerous additional embodiments are also possible.

### IV. BRIEF DESCRIPTION OF THE DRAWINGS

Other objects and advantages of the invention may become apparent upon reading the detailed description and upon reference to the accompanying drawings.

FIG. 1 is a block diagram illustrating a system for communicating information, in accordance with some embodiments.

FIG. 2 is a block diagram illustrating a network of systems for communicating information, in accordance with some embodiments.

FIG. 3 is a block diagram illustrating a builder for generating sequence instructions for controlling permitted sequences for the execution of documents by a user, in accordance with some embodiments.

FIG. 4 is a diagram representing the sequence instructions for controlling the permitted sequences for the execution of documents by a user as a hierarchical tree structure, in accordance with some embodiments.

FIG. 5 is a flow diagram illustrating a method for creating a sequence of instructions to define a set of permitted sequences for controlling an execution of a plurality of documents, in accordance with some embodiments.

FIG. 6 is a flow diagram illustrating an alternative method for creating a sequence of instructions to define a set of permitted sequences for controlling an execution of a plurality of documents, in accordance with some embodiments.

FIG. 7 is a flow diagram illustrating a method for executing a plurality of documents by receiving and interpreting sequence instructions configured to define a set of permitted sequences for the plurality of documents, in accordance with some embodiments.

FIG. 8 is a flow diagram illustrating a method for creating a sequence of instructions to define a set of permitted sequences for controlling an execution of a plurality of documents, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### V. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

In some embodiments, sequence instructions are created to define a set of permitted sequences with which to execute a plurality of documents. As used here, a document may be a content element, such as video, audio, text, etc. but may also be a batch file, a link, an executable file, etc. Sequence instructions may be, for example, logical operators (such as if, or, and, etc.) and may also include other events such as (play video, play audio, dial phone, launch e-mail application, execute batch file). The sequence instructions may also be extended as necessary to accommodate specialized applications.

In some embodiments, the sequence instructions may be generated using a builder. In some embodiments, the builder may use a command line-type interface, and in other embodiments, the builder may use a graphical interface, in order to define nodes that the set of permitted sequences can follow. Nodes are “vertices” in the various “paths” that may be followed by the various sequences. A designer may begin, for example, by dragging and dropping a node into a design sheet in a window of the builder. The designer may then insert one or more of many events from a graphical representation of an event library into each node. The graphical interface of the builder enables the designer to graphically visualize the set of permitted sequences defined by the sequence instructions. In some embodiments, the nodes may be organized in a tree structure.

In some embodiments, for some events (such as playing a video clip, for example), dragging the event into the editor automatically creates a node. Alternatively, for multiple events, a blank node may be inserted first and then multiple events may be inserted into that node.

In some embodiments, the sequence instructions are configured to be interpreted by an active user interface (AUI). The sequence instructions may be sent to a user (recipient) by another user (sender), for example, through a network such as the Internet or by any other means. The recipient may, through the active user interface, follow any one of the permitted sequences. The active user interface is configured to interpret the sequence instructions and deliver content, etc. to a recipient according to the control limits defined by the sequence instructions. The recipient thus assumes partial control over the sequence by choosing from the set of permitted sequences. In some embodiments, the control over the sequence followed is shared between the designer/sender and the recipient.

In some embodiments, information related to the sequence selected by the recipient may be recorded in a log file. The recorded information may be used for various purposes. For example, the log file may be used by the recipient to re-experience the sequence at a later time. The log file may also be sent to other users so that the other users can experience what the first user experienced. The log file may also be sent back to the designer so that the designer can monitor the progress of a user. In some embodiments, the designer may accordingly modify the sequence instructions after receiving the log file. In some embodiments, the sequence instructions as well as the log file may contain copyrightable information on the order of execution of the documents.

In some embodiments, the sequence instructions may be maintained separately from the documents associated with the permitted sequences defined by the sequence instructions and the sequence instructions may also be maintained separately from the active user interface designed to interpret the sequence instructions. For example, the sequence instructions may be designed using the builder and then transmitted to an active user interface. The documents may be stored at various locations and transmitted to the active user interface in response to the sequence instructions being interpreted by the active user interface.

In some embodiments, the communication entropy (or comtropy) may be computed for a set of sequence instructions. The comtropy may be defined as the product of the probability a certain sequence is followed and the logarithm of that probability. Typically, the comtropy for a set of sequence instructions is between a minimum value and a maximum value. A comtropy may be a measure of the amount of control given to a user by a set of sequence instructions. Thus, a designer may adjust the amount of control associated with a set of sequence instructions by adjusting the comtropy associated with the set of sequence instructions.

It should be noted that as used herein, the term “user” can refer to a designer, a sender, or a recipient.

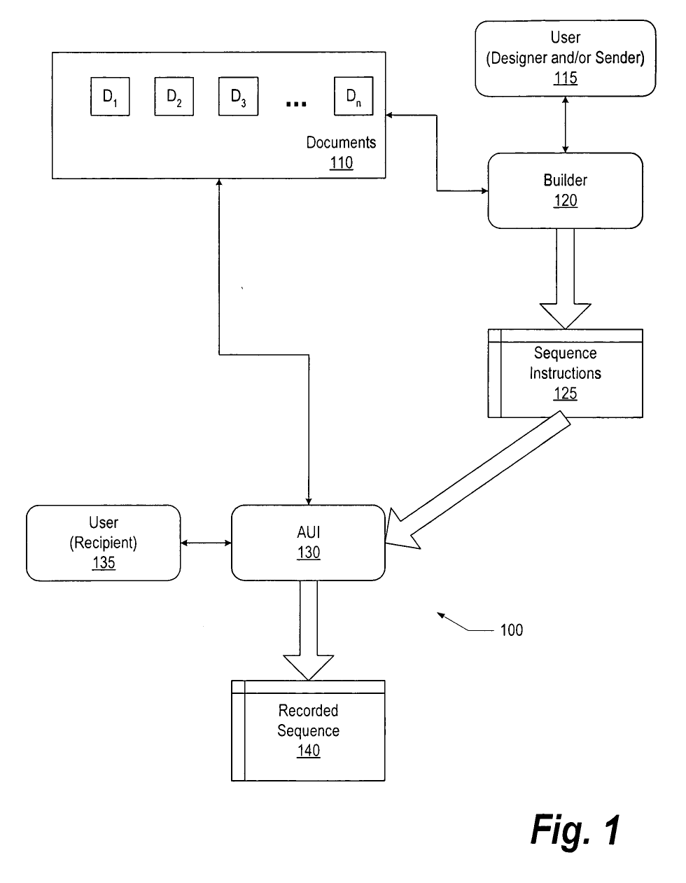

FIG. 1 is a block diagram illustrating a system for communicating information, in accordance with some embodiments. Communication of information generally includes a user (designer and/or sender) sending information to another user (recipient) who receives the information. In some embodiments, communication system 100 may be used to facilitate the communication of information between user 115 and user 135. In some embodiments, user 135 may be the recipient of information sent by user 115 through communication system 100.

As shown in FIG. 1, communication system 100 includes builder 120, which may be used to design sequence instructions 125. In some embodiments, builder 120 may also be used to send sequence instructions 125. Sequence instructions 125 may be used to define a set of permitted sequences that define the order with which documents 110 may be interpreted and experienced by user 135. A document may be a content element, such as video, audio, text, but may also be a batch file, a link, an executable file, etc. Builder 120 as well as active user interface 130 may also be configured to operate with other types of documents that may be suitable to other applications. The combination of a particular sequence selected from the set of permitted sequences with one or more of documents 110 that are executed in response to selecting the particular sequence represent the information communicated to user 135.

Sequence instructions 125 may be, for example, logical operators (such as if, or, and, etc.) and could also include other events such as (play video, play audio, dial phone, launch e-mail application, execute batch file). The sequence instructions may also be extended as necessary to accommodate other applications. Sequence instructions 125 may be sent to user 135 through a network such as the Internet or by any other means. For example, sequence instructions 125 may be sent via e-mail to user 135. Alternatively, sequence instructions 125 may be uploaded to a server by user 115 and subsequently downloaded by user 135.

In some embodiments, user 115 may be the designer of the sequence instructions. User 115 may be a person or a computer that may be configured to create sequence instructions using builder 120. In other embodiments, designer 115 may be a combination between a person and a computer. User 115 may also be the sender of the sequence instructions. It should be noted that the designer and sender of the sequence instructions may be the same or different entities.

In some embodiments, builder 120 may be implemented using a graphical user interface to define the nodes for the set of permitted sequences. In some embodiments, the nodes may be organized in a tree structure. A designer may begin, for example, by dragging and dropping a node into a design sheet. The designer may then insert one of many events from a graphical representation of an event library into each node. The graphical interface of the builder enables the designer to graphically visualize the set of permitted sequences defined by the sequence instructions.

Active user interface 130 is configured to interpret sequence instructions 125 in order for user 135 to select a sequence to follow from the set of permitted sequences as defined by sequence instructions 125. Active user interface 130 is also configured to manage the receiving, presenting, and executing of documents 110 for user 135 according to control limits contained in sequence instructions 125. User 135 thus assumes partial control over the sequence selection by choosing from the set of permitted sequences. In some embodiments, the control over the sequence followed is shared between user 115 and user 135. Thus, once user 135 receives and runs sequence instructions 125 through active user interface 130, certain documents from documents 110 will be retrieved and executed in response to user 135 exerting control over sequence selection. However, depending on the degree of control retained by user 115 over sequence selection, certain other documents may automatically be transmitted and executed without requiring any action on the part of user 135.

In some embodiments, active user interface 130 may be a plug-in to a standard web browser. The plug-in may be configured to allow sequence instructions to update a web page as documents are executed without requiring a refresh of the web page.

In some embodiments, sequence instructions 125 may be maintained separately from documents 110. Such separation allows the documents to be modified or replaced without modifying the sequence instructions. Documents 115 may be stored on any storage device accessible to active user interface 130. As active user interface 130 interprets sequence instructions 125, it may retrieve a particular document at the time when the document is to be executed in connection with the interpretation of a particular instruction in sequence instructions 125. When documents are retrieved and executed in real time as sequence instructions are being interpreted, it is possible that a user of the active user interface may experience delays. Accordingly, active user interface 130 may be configured to execute a local file in order to create the illusion of no delay until the required document is downloaded. Alternatively, active user interface 130 may be configured pre-fetch certain documents prior to the point in a sequence when the document is needed. For example, the active user interface may be configured to determine the probability of one or more of documents being executed at future points in possible sequences and retrieve such documents in response such determination.

In some embodiments, information associated with the sequence selected by the user may be recorded in a log file. The log file may be store locally or uploaded to a designated server. The recorded information may be used for various purposes. For example, the log file may be used by the user to re-experience the sequence at a later time. The log file may also be sent to other users so that the other users can experience what the first user experienced. The log file may also be sent back to the designer so that the designer can monitor the progress of a user. In some embodiments, the designer may accordingly modify the sequence instructions after receiving the log file.

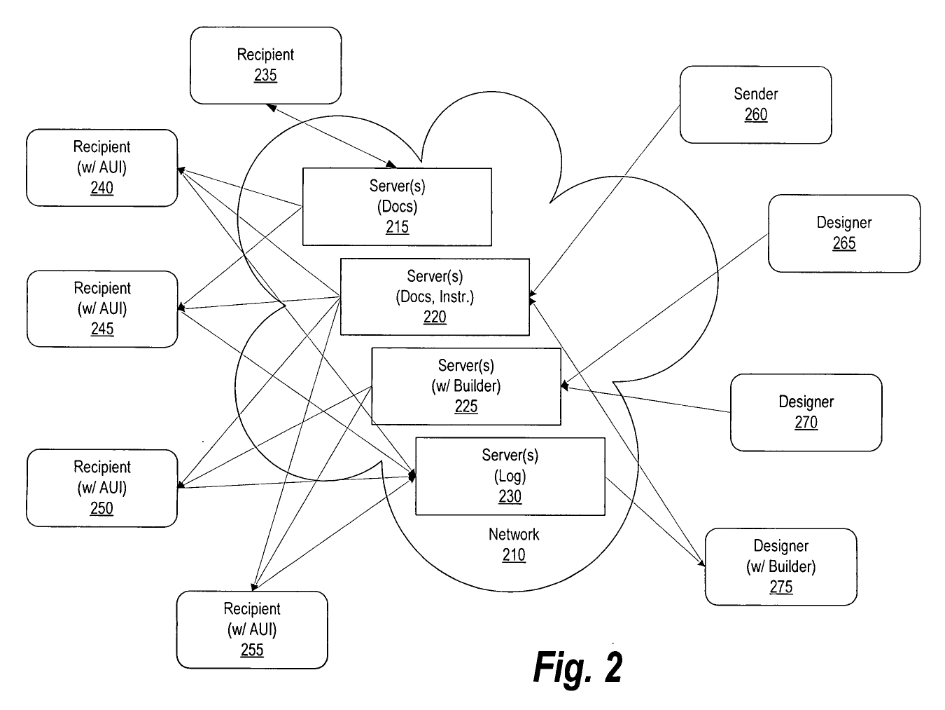

FIG. 2 is a block diagram illustrating a network of systems for communicating information, in accordance with some embodiments.

It should be noted that server as used herein may also refer to multiple servers. Thus, if information is shown as residing one a single server, it should be understood that the information may be distributed over multiple servers.

Multiple systems may be connected with each other through network 210 such as the Internet. In the example shown, server 215 may be configured to store some of the documents that contain the content to be delivered to users through the various active user interfaces. Server 220 may be configured to store documents as well as sets of sequence instructions that were created by builders and may be accessed by various users through active user interfaces. Server 225 may be configured to host a builder. Designers that do not have access to a builder otherwise may access the builder hosted by server 225 in order to create sequence instructions. Server 230 may be configured to host log files containing recorded sequence information generated by users after experiencing a set of documents.

Recipient 235, for example, may receive documents from server 215. Sequence instructions may be sent to recipient 235 directly via e-mail, for example. Recipient 240 may, for example, receive sequence instructions from server 220 and documents from server 215. Recipient 240 may also upload recorded sequence information to server 230. Recipient 245 similarly may receive instructions from 220 and documents from server and documents from server 215. Recipient 240 may also upload recorded sequence information to server 230. Recipients 250 and 255 may receive sequence instructions from server 220 and may upload recorded sequence information to server 230. Recipients 250 and 255 may also design sequence instructions for other recipients using the builder hosted by server 225.

Sender 260 may upload instructions that may have been created by other designers to server 220 where the instructions may then be downloaded by recipients. Designers 265 and 270 may use the builder hosted by server 225 in order to design sequence instructions for one or more recipients. Designer 275 may design sequence instructions using an internal builder and may upload those instructions to server 220. Designer 275 may also receive recorded sequences from recipients from server 230.

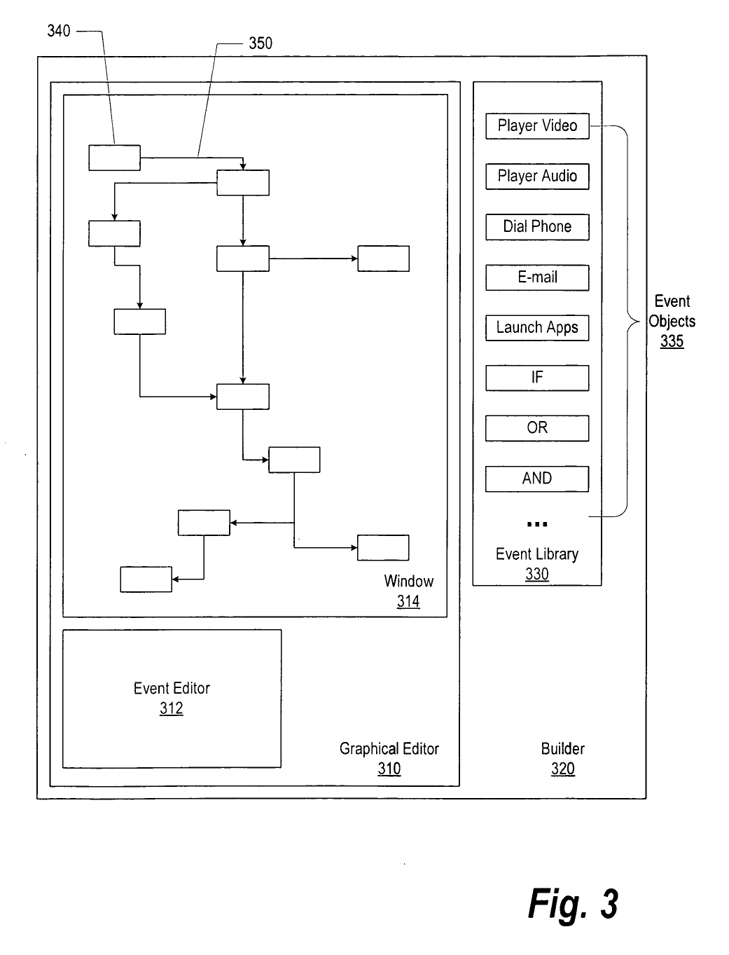

FIG. 3 is a block diagram illustrating a builder for generating sequence instructions for controlling permitted sequences for the execution of documents by a user, in accordance with some embodiments.

As shown in FIG. 3, builder 320 may include graphical editor 310 and event library 330. Graphical editor 310 allows a designer to graphically create a flow diagram corresponding to a set of permitted sequences by arranging nodes 340 on a design sheet in window 314 and linking such nodes with branches 350. Graphical editor 310 may include event editor 312. In some embodiments, the event editor may open in a separate window. In some embodiments, event editor 312 may contain controls for facilitating the creation and management of the flow diagram. In an alternative embodiment, the builder may use a command line-type interface to create sequence instructions. Builder 320 may be installed on the local computer of a designer or on a server located on a network accessible to the designer. Such a network may include a local area network, wider area network, metropolitan area networks, etc. Graphical editor 310 includes functionality for converting the graphical representation of the permitted sequences into a set of sequence instructions. For example, graphical editor 310 may include a save function for saving the graphical representation of the permitted sequences as well as a save as function permitting the graphical representation to be saved as sequence instructions. In some embodiments, the file format for the sequence instructions may be XML. However, other file formats are possible, including simple text file formats.

Event library 330 includes a collection of event objects shown in FIG. 3 as event objects 335. These event objects may be divided into two classes: action event objects and logical event objects. Action event objects are generally related to the execution of documents and may include actions such as “play video”, “play audio”, “send e-mail”, “launch applications”, “perform remote procedure call”, “read and check data”, “control peripheral devices”, etc. Logical event objects are generally related to controlling or managing sequence flow. Such objects may include logical operators such as “if”, “and”, “or”, “go to”, etc. Logical event objects may also include events such as “randomize”, “synchronize”, “loop”, “branch”, etc. In some embodiments, builder 320 may support the construction of customized event objects through an API.

Each of nodes 340 may be created by dragging and dropping one more of event objects 335 from event library 330 into window 314 of graphical editor 310. In some embodiments, for some events (such as playing a video clip, for example), dragging the appropriate event object into the editor automatically creates a node. Alternatively, a blank node may be inserted first and then one or more event objects may be inserted into that node. In some embodiments, a designer may use event editor 312 to enter specific information for the node being created, such as an identifier for the node, a description of the node, the address or identifier of a document to be associated with that node, etc. In another embodiment, each node may be automatically assigned a unique identifier by the builder. A designer may cut, copy, and paste any nodes or branches in constructing the flow diagram for the permitted sequences. In some embodiments, a designer may join one or more separate sets of sequence instructions to form combined sequence instructions.

In some embodiments, a designer may use the event editor to add keywords and other metadata to nodes. Such metadata may be used to facilitate searching, indexing, and categorizing sequence instructions and related documents.

In some embodiments, builder 320 may have encryption functionality that allows a designer to encrypt one or more of nodes 340. Alternatively, a designer may encrypt a file containing the sequence instructions.

In some embodiments, sequence instructions may include check nodes and synchronizing nodes. Check nodes may be used to monitor the progress of the execution of other sequence instructions. Synchronizing nodes may be used to synchronize the processing of multiple sequence instructions. Both check nodes and synchronizing nodes may be used to facilitate multi-threading of sequence instructions.

In some embodiments, sequence instructions may include nodes that establish a real-time connection between users. For example, a user following a certain sequence may select a node that launches an internet phone application to dial another user. Another node may, for example, initiate a video conference call between one or more users.

In some embodiments, responses to the user may be provided either using prerecorded messages or the responses may be provided by real person without the user necessarily knowing whether the user is communicating with a real person or listening to a recording. For example, answers to a student attending a course through the active user interface may be provided either using recordings of the professor or by the system calling the professor and having the professor provide the answers in real time.

In some embodiments, sequence instructions may include feedback nodes designed to transmit results or responses from users interpreting the sequence instructions during a communication session to one or more other computers or servers for the purpose of analyzing the responses. Feedback provided back to the builder based on such analysis may be used by the feedback node in connection with determining the next branch along a particular sequence. In some embodiments, the voice of the user may be analyzed, for example, in order to determine an emotional state of the user. In response thereto, an appropriate response may then be provided to the user.

In some embodiments, the sequence selection of the user may be monitored in real time and the sequence instructions may be modified while the user is interpreting the instructions depending on the actual selections made by the user.

Referring to FIG. 3, builder 300 may include a log file reader that permits the user of the builder to review the sequence selection information contained in sequence operation log (SOL) files sent from an AUI player residing on a recipient's computer. The SOL files may provide the user of the builder with feedback with which the builder user may use to modify the set of sequence instructions or a set of related sequence instructions. For example, in response to the frequency with which a user makes selections from a drop-down list, the order of the list may be changed so that those items are at the top of the list. In some embodiments, the builder and log file reader may be configured to permit the builder to automatically modify the sequence instructions in response to the log file reader receiving a SOL file.

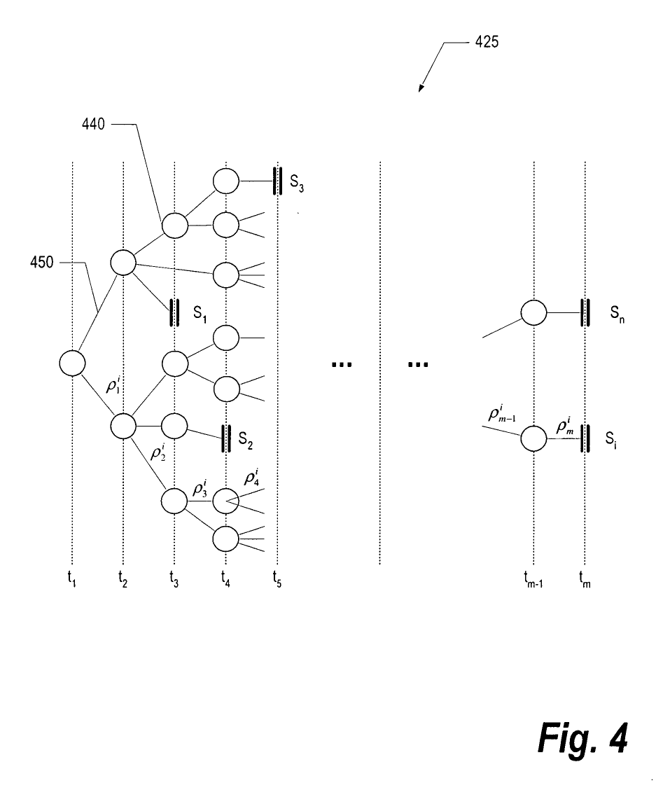

FIG. 4 is a diagram representing the sequence instructions for controlling the permitted sequences for the execution of documents by a user as a hierarchical tree structure, in accordance with some embodiments.

As used in the following discussion of FIG. 4, terms such as “documents”, “sequence instructions”, “nodes”, and “branches” have properties that are similar to like-named elements as used in the discussion of prior figures. Each document in a set of documents may be represented by Dᵢ, and the set of documents may be represented as

D=D(m)=[D1, D2, D3, . . . , Di, . . . , Dm],

where m is the total number of documents in the set.

Document sequences correspond to the possible orderings in which the documents may be presented and executed. Each sequence may be represented by Sᵢ, and the set of possible sequences corresponding to the set of possible documents D^{(m)} may be represented by

S=S(D(m))={S1, S2, S3, . . . , Si, . . . , Sn(m)},

where the total number of possible sequences, n(m), is given by

$$n ( m ) = {\sum }_{k = 1}^{m} m ! / ( m - k ) !$$

The probability of any sequence Sᵢ being chosen may be defined as pᵢ. The corresponding probabilities may be designated by the following set:

$$P = {P}^{n} = P ( {S}^{( n )} ) = \{ {p}_{1} , {p}_{2} , {p}_{3} , … , {p}_{i} , … , {p}_{n} \} , \\ where {\sum }_{j = 1}^{n} {p}_{j} = 1.$$

A communication entropy (or comtropy) for a communication system may be defined as a measure for the degree of control given to users over information communicated in the communication system. In some embodiments, the comtropy may be defined as

$$H ( P ) = - {\sum }_{j = 1}^{n} {p}_{j} log {p}_{j}$$

In synchronous communication, a sender maintains full control over sequence selection. If a particular sequence Sᵢ is chosen by the sender, the set of permitted sequences is restricted to that single sequence and the probabilities are given by

P={0, 0, 0, . . . , pi=1, . . . , 0}.

The comtropy for the synchronous case is given by

H_{synch}=H(0, 0, 0, . . . , 1, . . . , 0)=0,

which represents a minimum for the comtropy.

For asynchronous communication, the sender has no control over the selection of sequences, and the probability of each sequence Sᵢ being selected is pᵢ=1/n. The comtropy for asynchronous communication is

H_{asynch}=H(1/n, 1/n, 1/n, . . . , 1/n, . . . , 1/n)=log n,

which represents a maximum for the comtropy.

A communication system may be defined as being in para-synchronous communication if the sender maintains partial control over the selection of sequences, in which case the comtropy is given by

0<H<log n.

If a system also includes the synchronous and asynchronous modes, it may be defined as pan-synchronous, in which case the comtropy is given by

0≦H≦log n.

It should also be noted that information (or information transfer) may be anything that, when received by a user, reduces the amount of uncertainty in the user's knowledge. Document sequences carry information that documents do not contain. This information gets lost as comtropy increases. As communication moves from synchronous to asynchronous, there is a loss in information equal given by

Iₗₒₛₛ=ΔH=H_{asynch}−H_{synch}=log n.

Returning to FIG. 4, sequence instructions 425, corresponding to a set of permitted sequences S, are represented as a hierarchical tree structure having nodes 440 linked by branches 450. Each node may be generally represented by the symbol ◯. End nodes are represented by the symbol ∥. End nodes denote the end point of a particular sequence, which corresponds to the end of a communication session between users if that particular sequence is followed.

A communication session corresponding to one of the sequences in S will eventually be carried out following the various paths traced by the branches. FIG. 4 shows the branch probability ρₖⁱ at time tₖ for sequence Sᵢ. This represents the probability that a particular branch will be followed in response to a document at the corresponding node for that branch being executed. The total probability pᵢ associated with sequence Sᵢ being selected may be calculated as

$${p}_{i} = {ρ}_{1}^{i} \cdot {ρ}_{2 }^{i} … {ρ}_{m}^{i} = {\prod }_{k = 1}^{m} {ρ}_{k}^{i} .$$

The branch probabilities may depend on the control limits configured into the sequence instructions. In some embodiments, sequence instructions may be configured to provide a first degree of control over the selection of the sequence of the set of documents to a first user, such as a sender, and a second degree of control over the selection of the sequence of the set of documents to a second user, such as a recipient. In this manner control may be shared between the sender and recipient. Thus, one of ordinary skill in the art will appreciate that the comtropy corresponding to the set of possible sequences generated by sequence instructions 425 may have a value that is between zero and logn. That is, sequence instructions 425 may be used to facilitate pan-synchronous communication. A designer may dynamically adjust the level of synchronization between a sender and a recipient to any desired level in a communication system by appropriately modifying the control limits in the sequence instructions. Alternatively, the amount of control provided to a user may be increased or decreased by adjusting the comtropy associated with the set of sequence instructions.

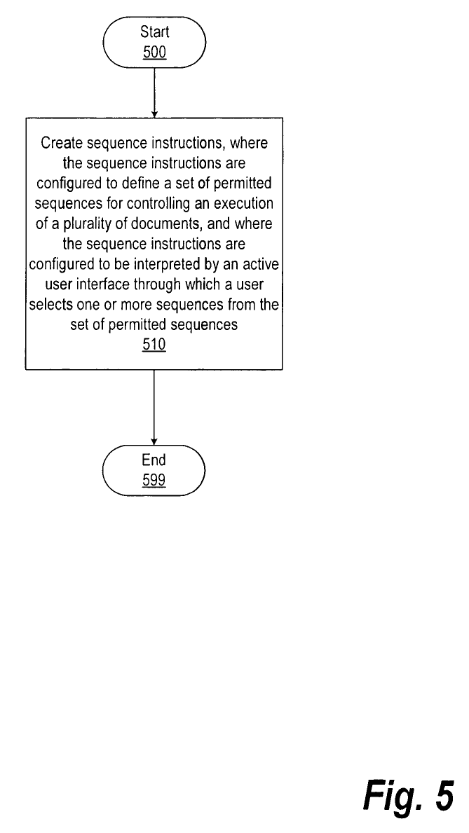

FIG. 5 is a flow diagram illustrating a method for creating a sequence of instructions to define a set of permitted sequences for controlling an execution of a plurality of documents, in accordance with some embodiments.

In some embodiments, the method shown here may be performed by the system shown in FIG. 1. Processing begins at 500 whereupon, at block 510, sequence instructions are created. The sequence instructions are configured to define a set of permitted sequences for controlling an execution of a plurality of documents. The sequence instructions are also configured to be interpreted by an active user interface through which a user (recipient) can select one or more sequences from the set of permitted sequences.

With the sequence instructions, a designer may establish control over the sequence with which a user may execute and/or experience the plurality of the documents. The designer through the sequence instructions may establish how the control is divided between the designer and the user (recipient). In some embodiments, the sequence instructions are maintained separately from the documents and also maintained separately from the active user interface designed to interpret the instructions. In some embodiments, the sequence instructions may be represented using one or more nodes organized in a tree structure and may be created and edited using a graphical user interface.

Processing subsequently ends at 599.

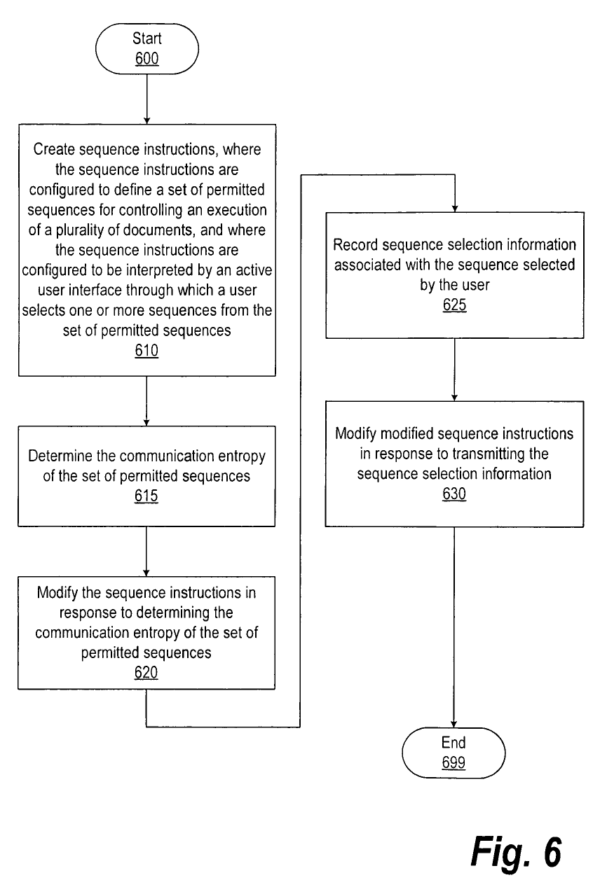

FIG. 6 is a flow diagram illustrating an alternative method for creating a sequence of instructions to define a set of permitted sequences for controlling an execution of a plurality of documents, in accordance with some embodiments.

In some embodiments, the method shown here may be performed by the system shown in FIG. 1. Processing begins at 600 whereupon, at block 610, sequence instructions are created. The sequence instructions are configured to define a set of permitted sequences for controlling an execution of a plurality of documents. The sequence instructions are also configured to be interpreted by an active user interface through which a user can select one or more sequences from the set of permitted sequences.

With the sequence instructions, the designer may establish control over the sequence with which a user may execute and/or experience the plurality of the documents. The designer through the sequence instructions may establish how the control is divided between the designer and the user. In some embodiments, the sequence instructions are maintained separately from the documents and also maintained separately from the active user interface designed to interpret the instructions. In some embodiments, the sequence instructions may be represented using one or more nodes organized in a tree structure and may be created and edited using a graphical user interface.

In some embodiments, the set of permitted sequences has a communication entropy between a minimum entropy value and a maximum entropy value. The communication entropy value may be used as an indicator of the amount of control retained by the designer compared to the amount of control provided to the user. A low communication entropy value indicates that more of the control is with the designer and a high communication entropy value indicates that more of the control is with the user.

At block 615, the communication entropy of the set of permitted sequences is determined. In some embodiments, the value may be an indicator of the control distribution between the designer and the user. At block 620, the sequence instructions are modified in response to determining the communication entropy of the permitted sequences.

At block 625, the sequence selection information associated with the sequence selected by the user is recorded. The selected information may be recorded, for example, so that another user may follow the same sequence to experience the documents in the same order. The selected information may also be recorded, for example, so that that the same user can experience again at a later time the same sequence.

At block 630, the sequence instructions are modified in response to receiving the sequence selection information. The sequence instructions may be modified, for example, after it is determined that a user frequently has certain preferences over others.

Processing subsequently ends at 699.

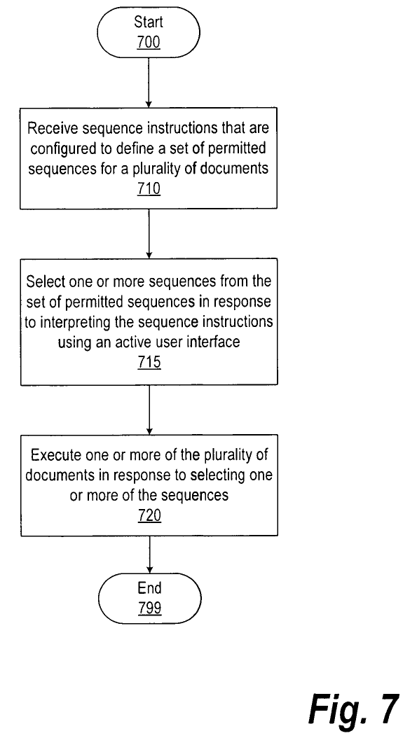

FIG. 7 is a flow diagram illustrating a method for executing a plurality of documents by receiving and interpreting sequence instructions configured to define a set of permitted sequences for the plurality of documents, in accordance with some embodiments.

In some embodiments, the method shown here may be performed by the system shown in FIG. 1. Processing begins at 700 whereupon, at block 710, sequence instructions are received. The sequence instructions are configured to define a set of permitted sequences for a plurality of documents that may be received and experienced.

At block 715, one or more sequences from the set of permitted sequences are selected in response to interpreting the instructions using an active user interface, and at block 720, one or more of the plurality of documents is executed in response to selecting one or more of the sequences.

The sequence instructions establish control over the sequence with which a user may execute and/or experience the plurality of the documents. The designer through the sequence instructions may establish how the control is divided between the designer and the user. In some embodiments, the sequence instructions are maintained separately from the documents and also maintained separately from the active user interface designed to interpret the instructions. In some embodiments, the sequence instructions may be represented using one or more nodes organized in a tree structure and may be created and edited using a graphical user interface.

Processing subsequently ends at 799.

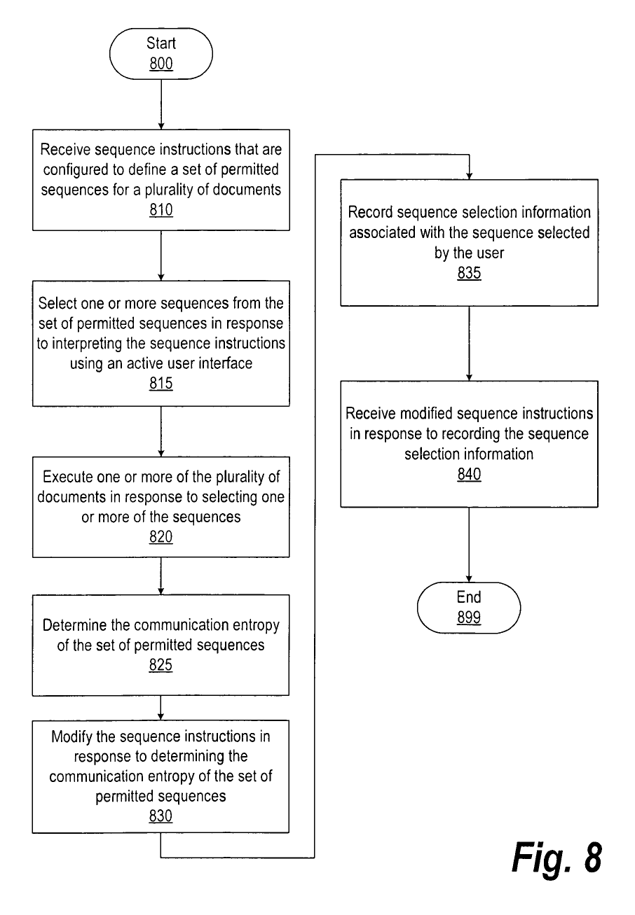

FIG. 8 is a flow diagram illustrating a method for creating a sequence of instructions to define a set of permitted sequences for controlling an execution of a plurality of documents, in accordance with some embodiments.

In some embodiments, the method shown here may be performed by the system shown in FIG. 1. Processing begins at 800 whereupon, at block 810, sequence instructions are received. The sequence instructions are configured to define a set of permitted sequences for a plurality of documents that may be received and experienced.

At block 815, one or more sequences from the set of permitted sequences are selected in response to interpreting the instructions using an active user interface, and at block 820, one or more of the plurality of documents is executed in response to selecting one or more of the sequences.

The sequence instructions establish control over the sequence with which a user may execute and/or experience the plurality of the documents. The designer through the sequence instructions may establish how the control is divided between the designer and the user. In some embodiments, the sequence instructions are maintained separately from the documents and also maintained separately from the active user interface designed to interpret the instructions. In some embodiments, the sequence instructions may be represented using one or more nodes organized in a tree structure and may be created and edited using a graphical user interface.

In some embodiments, the set of permitted sequences has a communication entropy between a minimum entropy value and a maximum entropy value. The entropy value may be used as an indicator of the amount of control retained by the designer compared to the amount of control provided to the user. A low entropy value indicates that more of the control is with the designer and a high entropy value indicates that more of the control is with the user.

At block 825, the communication entropy of the set of permitted sequences is determined. In some embodiments, the value may be an indicator of the control distribution between the designer and the user. At block 830, the sequence instructions are modified in response to determining the entropy of the permitted sequences.

At block 835, the sequence selection information associated with the sequence selected by the user is recorded. The selected information may be recorded, for example, so that another user may follow the same sequence to experience the documents in the same order. The selected information may also be recorded, for example, so that the same user can experience the same sequence again at a later time.

At block 840, modified sequence instructions are received in response to receiving the sequence selection information. The sequence instructions may be modified, for example, after it is determined that a user frequently has certain preferences over others.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for communicating information, the method comprising creating sequence instructions, where the sequence instructions are configured to define a set of permitted sequences for controlling an execution of a plurality of documents, and where the sequence instructions are configured to be interpreted by an active user interface through which a user selects one or more sequences from the set of permitted sequences.

2. The method of claim 1, where the sequence instructions are maintained separately from the plurality of documents.

3. The method of claim 1, where the set of permitted sequences has a communication entropy between a minimum entropy value and a maximum entropy value and the method further comprising modifying the sequence instructions in response to determining the communication entropy of the set of permitted sequences.

4. The method of claim 1, further comprising:
recording sequence selection information associated with the one or more sequences selected by the user; and
modifying the sequence instructions in response to receiving the sequence selection information.

5. A system for communicating information, the system comprising:
one or more processors;
one or more memory units coupled to the one or more processors;
the system being configured to create sequence instructions, where the sequence instructions are configured to define a set of permitted sequences for controlling an execution of a plurality of documents, and where the sequence instructions are configured to be interpreted by an active user interface through which a user selects one or more sequences from the set of permitted sequences.

6. The system of claim 5, where the sequence instructions are maintained separately from the plurality of documents.

7. The system of claim 5, where the set of permitted sequences has a communication entropy between a minimum entropy value and a maximum entropy value, the system being further configured to modify the sequence instructions in response to determining the communication entropy of the set of permitted sequences.

8. The system of claim 5, the system being further configured to record sequence selection information associated with the one or more sequences selected by the user, the system being further configured to modify the sequence instructions in response to receiving the sequence selection information.

9. A computer program product stored on a computer operable medium, the computer program product comprising software code being effective to create sequence instructions, where the sequence instructions are configured to define a set of permitted sequences for controlling an execution of a plurality of documents, and where the sequence instructions are configured to be interpreted by an active user interface through which a user selects one or more sequences from the set of permitted sequences.

10. The product of claim 9, where the sequence instructions are maintained separately from the plurality of documents.

11. The product of claim 9, where the set of permitted sequences has a communication entropy between a minimum entropy value and a maximum entropy value, the code being further effective to modify the sequence instructions in response to determining the communication entropy of the set of permitted sequences.

12. The product of claim 9, the code being further effective to record sequence selection information associated with the one or more sequences selected by the user, the code being further effective to modify the sequence instructions in response to receiving the sequence selection information.

13. A method for communicating information, the method comprising:
receiving sequence instructions, where the sequence instructions are configured to define a set of permitted sequences for a plurality of documents;
selecting one or more sequences from the set of permitted sequences in response to interpreting the sequence instructions using an active user interface; and
executing one or more of the plurality of documents in response to selecting one or more of the sequences.

14. The method of claim 13, where the sequence instructions are maintained separately from the plurality of documents.

15. The method of claim 13, where the set of permitted sequences has a communication entropy between a minimum entropy value and a maximum entropy value, the method further comprising modifying the sequence instructions in response to determining the communication entropy of the set of permitted sequences.

16. The method of claim 13, further comprising:
recording sequence selection information associated with the sequence selected by the user; and
receiving modified sequence instructions in response to transmitting the sequence selection information.

17. A system for communicating information, the system comprising:
one or more processors;
one or more memory units coupled to the one or more processors;
the system being configured to:
receive sequence instructions, where the sequence instructions are configured to define a set of permitted sequences for a plurality of documents;
select one or more sequences from the set of permitted sequences in response to interpreting the sequence instructions using an active user interface; and
execute one or more of the plurality of documents in response to selecting one or more of the sequences.

18. The system of claim 17, where the sequence instructions are maintained separately from the plurality of documents.

19. The system of claim 17, where the set of permitted sequences has a communication entropy between a minimum entropy value and a maximum entropy value, the system being further configured to modify the sequence instructions in response to determining the communication entropy of the set of permitted sequences.

20. The system of claim 17, the system being further configured to record sequence selection information associated with the sequence selected by the user, the system being further configured to modify sequence instructions in response to transmitting the sequence selection information.

21. A computer program product stored on a computer operable medium, the computer program product comprising software code being effective to:
receive sequence instructions, where the sequence instructions are configured to define a set of permitted sequences for a plurality of documents;
select one or more sequences from the set of permitted sequences in response to interpreting the sequence instructions using an active user interface; and
execute one or more of the plurality of documents in response to selecting one or more of the sequences.

22. The product of claim 21, where the sequence instructions are maintained separately from the plurality of documents.

23. The product of claim 21, where the set of permitted sequences has a communication entropy between a minimum entropy value and a maximum entropy value, the code being further effective to modify the sequence instructions in response to determining the communication entropy of the set of permitted sequences.

24. The product of claim 21, the code being further effective to record sequence selection information associated with the sequence selected by the user, the code being further effective to modify sequence instructions in response to transmitting the sequence selection information.
